(19) United States
(12) Patent Application Publication
(10) Pub. No.: US 2009/0089463 A1
(43) Pub. Date: Apr. 2, 2009

(54) Information Processing Device, Device Access Control Method, and Device Access Control Program

(75) Inventor: Norihisa Iga, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/720,514

(22) PCT Filed: Nov. 17, 2005
(86) PCT No.: PCT/JP2005/021167

§ 371 Date: May 30, 2007

(30) Foreign Application Priority Data
Nov. 30, 2004 (JP) 2004-346661

(51) Int. Cl. G06F 3/00; G06F 9/46

(52) U.S. Cl. 710/37; 719/321

(57) ABSTRACT

An information processing device, a device access control method, and a device access control program are provided. When a device built in or mounted on the information processing device is controlled, the OS manages access to the device driver, so as to restrict the use of the device. When issuing a control instruction to a device driver (22) that controls a device (4), an application (1) accesses a system call unit (21) in the OS (2). The system call unit (21) inquires at an access determining unit (31), so as to confirm that the application (1) is allowed to access the device driver (22). After confirming that the application (1) is allowed to access the device driver (22), the system call unit (21) transfers the control instruction to the device driver (22). When a new device (4) is connected, the access determining unit (31) determines whether the application (1) is allowed to control the device (4). If the access determining unit (31) determines that the application (1) is allowed to control the device (4), an automatic driver incorporating unit (23) incorporates the device driver (22) controlling the device (4) into the OS (2). Through the above operation, unauthorized use of the device (4) can be prevented. Also, since access to the device driver (22) is controlled by the OS (2), the device (4) can be controlled based on the existence of the right of use, without a change of the code of the existing device driver (22) controlling the device (4).

### TECHNICAL FIELD

The present invention relates to an information processing device, a device access control method, and a device access control program, and more particularly, to an information processing device, a device access control method, and a device access control program that limit the use of devices built in or mounted on the information processing device through the OS controlling the access to corresponding device drivers.

### BACKGROUND ART

A personal computer is normally equipped with various input/output devices such as a keyboard, a mouse, a floppy (registered trade mark) disk drive unit, a display, and a printer. In such a personal computer, a data processing unit formed with a CPU and a memory (a ROM or a RAM) executes various application programs under the control of the operating system, so as to perform various data processing operations such as an image processing operation, a document creating and editing operation, and a data retrieving operation. In the operating system, the number of device drivers provided is the same as the number of drivers. The device drivers are specially provided for controlling the respective input/output devices.

Patent Document 1 discloses a computer security system and a computer security method with and by which the restrictions of access to the computer resources can be readily changed in various manners, under the conditions such as license conditions that are set at the time of execution of an application program. Patent Document 1 also discloses a computer-readable memory medium that stores a program for operating the computer security system and utilizing the computer security method.

Patent Document 2 discloses a file access device that is used in a file access terminal that can access one file under different names through an operating system that manages a file system. This file access device includes a memory that stores information about access rights associated with the respective names, and access processing means for accessing a file, using the access right corresponding to a name based on the contents of the memory.

Patent Document 3 discloses a device driver control method for facilitating the addition of a device by changing device driver registration information, instead of modifying the device driver, and an information processing device that utilizes this control method.

Patent Document 4 discloses a file system that is capable of reading and writing a file only through a certain program.

Patent Document 1: Japanese Patent Application Laid-Open (JP-A) No. 2004-13832

Patent Document 2: JP-A No. 8-335181

Patent Document 3: JP-A No. 10-27149

Patent Document 4: JP-A No. 5-100939

### DISCLOSURE OF THE INVENTION

### Problems to be Solved by the Invention

However, the above inventions have the following problems.

According to Patent Document 1, to limit the access to the computer resources, an application checks the existence of the right to access the computer resources. Therefore, the codes of the existing application need to be changed.

Patent Document 2 and Patent Document 4 cannot restrict access to a device that is built in a terminal or access to a device that is to be mounted on the terminal afterward. For example, in Linux, a device driver that is formed with a program for directly controlling a device is prepared in modules different from applications. An application operates the device driver via a system call unit in the OS, so as to control the device. The device driver is incorporated into the OS, and operates as a part of the OS. Therefore, such a device driver already incorporated into the OS cannot control access to the device by performing the same access control operation for a conventional file.

Also, in Patent Document 3, a dispatch device driver refers to the device driver registration information, and loads the device driver corresponding to the device number. However, this operation is designed to select a device driver used by a user, and cannot limit access to the device driver.

To solve the above problems, the present invention aims to provide an information processing device that performs in the OS access control on a device, without a change of the codes of the existing device driver controlling the device and the existing application that has used the device.

### Means for Solving the Problems

The invention according to claim 1 is an information processing device that controls at least one device connected to at least one device driver, comprising: an application that issues a control instruction to an operating system; and an access determining unit that determines whether to allow one of the device drivers to control one of the devices. The operating system includes: a system call unit that receives the control instruction, and allows the device driver to control the device; and the device drivers that control the devices.

The invention according to claim 2, in the information processing device according to claim 1, when the device is connected to the information processing device, the access determining unit determines whether the device can be controlled by the application, and the information processing device further comprises automatic driver incorporating means for incorporating a device driver of the device into the operating system when the access determining unit determines that the device can be controlled by the application.

The invention according to claim 3, in the information processing device according to claim 1 or 2, an error notification is sent to the application, when the access determining unit determines that the device driver is not allowed to control the device.

The invention according to claim 4, the information processing device according to any one of claims 1 to 3 further comprises notifying means for notifying a user of an error, when the access determining unit determines that the device driver is not allowed to control the device.

The invention according to claim 5, the information processing device according to any one of claims 1 to 4 further comprises: obtaining means for obtaining right-of-use information that indicates whether the use of the device driver is allowed; holding means for holding the right-of-use information obtained by the obtaining means; and control information converting means for converting the right-of-use information held by the holding means into control information that can be read by the access determining unit, wherein the access determining unit determines whether to allow the device driver to control the device, based on the control information converted by the control information converting unit.

The invention according to claim 6, in the information processing device according to claim 5, the right-of-use information includes conditions for using the right-of-use information, and the holding means determines that the right-of-use information is invalid when the conditions are not satisfied, and updates or deletes the right-of-use information.

The invention according to claim 7, in the information processing device according to claim 5 or 6, when the right-of-use information is obtained by the obtaining means, the holding means updates the right-of-use information to combined right-of-use information by combining the right-of-use information newly obtained by the obtaining means and the right-of-use information already held by the holding means.

The invention according to claim 8, in the information processing device according to any one of claims 5 to 7, when the right-of-use information held by the holding means is updated, added, or deleted, the control information corresponding to the right-of-use information is updated, added, or deleted.

The invention according to claim 9, in the information processing device according to any one of claims 1 to 8, the control instruction includes a device driver identifier for identifying the device driver, the control information includes device driver identification information for identifying the device driver, and the access determining unit searches for the control information, using the device driver identifier in the control instruction as a key. If the control information including the device driver identification information as to the device driver corresponding to the device driver identifier included in the control instruction is not found, the access determining unit determines not to allow the device driver to control the device.

The invention according to claim 10, in the information processing device according to any one of claims 1 to 8, the control instruction includes a device driver identifier for identifying the device driver, and the control information includes device driver identification information for identifying the device driver and application identification information for identifying the application. The system call unit adds an application identifier to the control instruction, the application identifier being for identifying the application that issues the control instruction, and the access determining unit searches for the control information, using the device driver identifier and the application identifier in the control instruction as a key. If the control information including the device driver identification information as to the device driver corresponding to the device driver identifier included in the control instruction and the application identification information as to the application corresponding to the application identifier included in the control instruction is not found, the access determining unit determines not to allow the device driver to control the device.

The invention according to claim 11, in the information processing device according to any one of claims 1 to 10, the access determining unit searches for control information as to a device driver associated with the device driver, when determining whether to allow the device driver to control the device. If the control information as to the device driver associated with the device driver is found, the access determining unit determines to allow the device driver to control the device.

The invention according to claim 12 is a device access control method to be utilized in an information processing device that includes an application that issues a control instruction to an operating system, and an access determining unit that determines whether to allow one of the device drivers to control one of the device, the operating system including a system call unit that receives the control instruction and allows the device driver to control the device, the operating system also including the device drivers that control the devices. This device access control method comprises the steps of: issuing the control instruction from the application; receiving the control instruction at the system call unit, when the control instruction is issued; determining, by the access determining unit, whether to allow the device driver to control the device, based on the control instruction, when the system call unit receives the control instruction; and allowing, through the system call unit, the device driver to control the device, when the access determining unit determines to allow the device driver to control the device.

The invention according to claim 13, in the device access control method according to claim 12, the information processing device further includes automatic driver incorporating means for incorporating a device driver of the device into the operating system. This device access control method further comprises the steps of: determining, by the access determining unit, whether the device can be controlled by the application, when the device is connected to the information processing device; and incorporating the device driver of the device into the operating system by the automatic driver incorporating means, when the access determining unit determines that the device can be controlled by the application.

The invention according to claim 14, the device access control method according to claim 12 or 13 further comprises the step of notifying the application of an error when the access determining unit determines not to allow the device driver to control the device.

The invention according to claim 15, the device access control method according to any one of claims 12 to 14 further comprises the step of notifying a user of an error when the access determining unit determines not to allow the device driver to control the device.

The invention according to claim 16, the device access control method according to any one of claims 12 to 15 further comprises the steps of: obtaining right-of-use information that indicates whether the use of the device driver is allowed; holding the right-of-use information obtained in the obtaining step; converting the right-of-use information into control information that can be read by the access determining unit, when the right-of-use information is held in the holding step; and determining, by the access determining unit, whether to allow the device driver to control the device, based on the control information converted in the control information converting unit, when the system call unit receives the control instruction.

The invention according to claim 17, in the device access control method according to claim 16, the right-of-use information includes conditions for using the right-of-use information. This device access control method further comprises the step of determining that the right-of-use information is invalid when the conditions are not satisfied, and updating or deleting the right-of-use information held in the holding step.

The invention according to claim 18, in the device access control method according to claim 16 or 17, when the right-of-use information is obtained in the obtaining step, the holding step includes updating the right-of-use information to combined right-of-use information by combining the right-of-use information newly obtained in the obtaining step and the right-of-use information already held in the holding step.

The invention according to claim 19, the device access control method according to any one of claims 16 to 18 further comprises the step of updating, adding, or deleting the control information corresponding to the right-of-use information held in the holding step, when the right-of-use information held in the holding step is updated, added, or deleted.

The invention according to claim 20, in the device access control method according to any one of claims 12 to 19, the control instruction includes a device driver identifier for identifying the device driver, and the control information includes device driver identification information for identifying the device driver. This device access control method further comprises the steps of: searching for the control information, with the use of a key that is the device driver identifier in the control instruction; and determining not to allow the device driver to control the device, when the control information including the device driver identification information as to the device driver corresponding to the device driver identifier included in the control instruction is not found, the searching step and the determining step being carried out by the access determining unit.

The invention according to claim 21, in the device access control method according to any one of claims 12 to 19, the control instruction includes a device driver identifier for identifying the device driver; and the control information includes device driver identification information for identifying the device driver and application identification information for identifying the application. This device access control method further comprises the steps of: adding an application identifier to the control instruction, the application identifier being for identifying the application that issues the control instruction, the adding step being carried out by the system call unit; searching for the control information, with the use of a key that is formed with the device driver identifier and the application identifier in the control instruction; and determining not to allow the device driver to control the device, when the control information including the device driver identification information as to the device driver corresponding to the device driver identifier included in the control instruction and the application identification information as to the application corresponding to the application identifier included in the control instruction is not found, the searching step and the determining step being carried out by the access determining unit.

The invention according to claim 22, the device access control method according to any one of claims 12 to 21 further comprises the steps of: searching for control information as to a device driver associated with the device driver, when determining whether to allow the device driver to control the device; and determining to allow the device driver to control the device, when the control information as to the device driver associated with the device driver is found, the searching step and the determining step being carried out by the access determining unit.

The invention according to claim 23, is a device access control program to be executed in an information processing device that includes an application that issues a control instruction to an operating system, and an access determining unit that determines whether to allow one of the device drivers to control one of the device, the operating system including a system call unit that receives the control instruction and allows the device driver to control the device, the operating system also including the device drivers that control the devices. This device access control program is executed to carry out the procedures of: issuing the control instruction from the application; receiving the control instruction at the system call unit, when the control instruction is issued; determining, by the access determining unit, whether to allow the device driver to control the device, based on the control instruction, when the system call unit receives the control instruction; and allowing, through the system call unit, the device driver to control the device, when the access determining unit determines to allow the device driver to control the device.

The invention according to claim 24, in the device access control program according to claim 23, the information processing device further includes automatic driver incorporating means for incorporating a device driver of the device into the operating system. This device access control program is executed to further carry out the procedures of: determining, by the access determining unit, whether the device can be controlled by the application, when the device is connected to the information processing device; and incorporating the device driver of the device into the operating system by the automatic driver incorporating means, when the access determining unit determines that the device can be controlled by the application.

The invention according to claim 25, the device access control program according to claim 23 or 24 is executed to further carry out the procedure of notifying the application of an error when the access determining unit determines not to allow the device driver to control the device.

The invention according to claim 26, the device access control program according to any one of claims 23 to 25 is executed to further carry out the procedure of notifying a user of an error when the access determining unit determines not to allow the device driver to control the device.

The invention according to claim 27, the device access control program according to any one of claims 23 to 26 is executed to further carry out the procedures of obtaining right-of-use information that indicates whether the use of the device driver is allowed; holding the right-of-use information obtained in the obtaining procedure; converting the right-of-use information into control information that can be read by the access determining unit, when the right-of-use information is held in the holding procedure; and determining, by the access determining unit, whether to allow the device driver to control the device, based on the control information converted in the converting procedure, when the system call unit receives the control instruction.

The invention according to claim 28, in the device access control program according to claim 27, the right-of-use information includes conditions for using the right-of-use information. This device access control program is executed to further carry out the procedures of determining that the right-of-use information is invalid when the conditions are not satisfied, and updating or deleting the right-of-use information held in the holding procedure.

The invention according to claim 29, in the device access control program according to claim 27 or 28, when the right-of-use information is obtained in the obtaining procedure, the holding procedure includes updating the right-of-use information to combined right-of-use information by combining the right-of-use information newly obtained in the obtaining procedure and the right-of-use information already held in the holding procedure.

The invention according to claim 30, the device access control program according to any one of claims 27 to 29 is executed to further carry out the procedure of updating, adding, or deleting the control information corresponding to the right-of-use information held in the holding procedure, when the right-of-use information held in the holding procedure is updated, added, or deleted.

The invention according to claim 31, in the device access control program according to any one of claims 23 to 30, the control instruction includes a device driver identifier for identifying the device driver, and the control information includes device driver identification information for identifying the device driver. This device access control program is executed to further carry out the procedures of: searching for the control information, with the use of a key that is the device driver identifier in the control instruction; and determining not to allow the device driver to control the device, when the control information including the device driver identification information as to the device driver corresponding to the device driver identifier included in the control instruction is not found, the searching procedure and the determining procedure being carried out by the access determining unit.

The invention according to claim 32, in the device access control program according to any one of claims 23 to 30, the control instruction includes a device driver identifier for identifying the device driver, and the control information includes device driver identification information for identifying the device driver and application identification information for identifying the application. This device access control program is executed to further carry out the procedures of: adding an application identifier to the control instruction, the application identifier being for identifying the application that issues the control instruction, the adding procedure being carried out by the system call unit; searching for the control information, with the use of a key that is formed with the device driver identifier and the application identifier in the control instruction; and determining not to allow the device driver to control the device, when the control information including the device driver identification information as to the device driver corresponding to the device driver identifier included in the control instruction and the application identification information as to the application corresponding to the application identifier included in the control instruction is not found, the searching procedure and the determining procedure being carried out by the access determining unit.

The invention according to claim 33, the device access control program according to any one of claims 23 to 32 is executed to further carry out the procedures of: searching for control information as to a device driver associated with the device driver, when determining whether to allow the device driver to control the device; and determining to allow the device driver to control the device, when the control information as to the device driver associated with the device driver is found, the searching procedure and the determining procedure being carried out by the access determining unit.

### EFFECTS OF THE INVENTION

In the present invention, when issuing a control instruction to a device driver that controls a device, an application accesses a system call unit in the OS. The system call unit inquires at an access determining unit, so as to confirm that the application is allowed to access the device driver. After confirming that the application is allowed to access the device driver, the system call unit transfers the control instruction to the device driver. When a new device is connected, the access determining unit determines whether the application is allowed to control the device. If the access determining unit determines that the application is allowed to control the device, an automatic driver incorporating unit incorporates the device driver controlling the device into the OS. Through the above operation, unauthorized use of the device can be prevented. Also, since access to the device driver is controlled by the OS, the device can be controlled based on the existence of the right of use, without a change of the code of the existing device driver controlling the device.

### EXEMPLARY EMBODIMENTS FOR CARRYING OUT THE INVENTION

The following is a description of exemplary embodiments.

### FIRST EXEMPLARY EMBODIMENT

Referring to FIG. 1, an information processing device in accordance with a first embodiment is described.

The information processing device in accordance with the first embodiment includes an application 1, an OS 2, an access control unit 3, and a device 4.

The application 1 operates a device driver 22 through a system call unit 21 of the OS 2, so as to control the operation of the device 4.

The OS 2 includes the system call unit 21, and the device driver 22. The system call unit 21 provides the functions of the OS 2 from the application 1. The functions of the OS 2 include the function of controlling access to the device driver 22 from the application 1. The system call unit 21 has the function of controlling access to the device driver 22, such as a startup access, a closing access, a readout access, a writing access, and other operation accesses. The system call unit 32 also has the function of calling an access determining unit 31 to determine whether the device 4 can be accessed. The device driver 22 is a program for controlling the device 4, and one device driver 22 is provided for each one device 4. The device driver 22 may be incorporated into the OS 2 in advance, or may be incorporated into the OS 2 after the information processing device is activated, if necessary.

The access control unit 3 includes the access determining unit 31, a control information converting unit 32, and a rights managing unit 33. The access control unit 3 might be incorporated into the information processing device in advance, or may be incorporated into the information processing device after the information processing device is activated, if necessary.

The access determining unit 31 has the function of determining whether the application 1 is allowed to access the device driver 22. The control information converting unit 32 has the function of converting right-of-use information sent from the rights managing unit 33 into information that can be read by the access determining unit 31. The rights managing unit 33 has the function of managing the right-of-use information as to the device driver 22. The right-of-use information may be sent from a server located at a remote place via a network, or a medium such as a CD-ROM mounted in an information processing device. If the right-of-use information is not used, and the control information converting unit 32 and the rights managing unit 33 are not provided, the access control unit 3 may be formed only with the access determining unit 31.

The device 4 is hardware that is formed with a display, a keyboard, and various sensors. The device 4 includes more than one set of hardware, so as to provide different functions in the single information processing device. Alternatively, devices 4 having different functions may be connected to an interface such as a USB or PCMCIA of the information processing device afterward, so as to turn the interface into one of the components of the device 4.

Referring now to FIGS. 2 and 3, the operation of the entire information processing device in accordance with this embodiment is described.

Referring to FIG. 2, an operation before access to the device driver 22 from the application 1 is described. First, the rights managing unit 33 obtains the right-of-use information for the device driver 22 from a remote server or a medium such as a CD-ROM (step A1). The right-of-use information may be generated within the information processing device. The right-of-use information contains at least device driver identification information for identifying the device driver 22 to be controlled. The device driver identification information held by the rights managing unit 33 is only required to contain information with which the device driver 22 can be identified based on a device driver identifier issued from the application 1. Accordingly, the device driver identification held by the rights managing unit 33 may not be the device driver identifier used by the application 1.

The rights managing unit 33 then transfers the obtained right-of-use information to the control information converting unit 32. The control information converting unit 32 converts the received right-of-use information into control information that can be read by the access determining unit 31 (step A2). The control information converting unit 32 then transfers the control information to the access determining unit 31. Through this converting procedure, the right-of-use information can be turned into the control information with which the access determining unit 31 can determine whether access is allowed.

After receiving the control information, the access determining unit 31 stores the control information received from the control information converting unit 32 (step A3), so as to promptly respond to an inquiry to be sent from the system call unit 21 to the device driver 22 as to whether access is allowed.

In a certain situation, the rights managing unit 33 may obtain control information that can be read by the access determining unit 31. When the rights managing unit 33 receives the control information from a remote server, a CD-ROM, or the like, the control information converting unit 32 does not carry out the converting procedure, and transfers the control information to the access determining unit 31. In this case, the control information may also be obtained from a remote server or a medium such as a CD-ROM, or may be generated within the information processing device. Where the right-of-use information is not used and only the control information is used, the information processing device may not include the rights managing unit 33 and the control information converting unit 32.

The operation shown in FIG. 2 is performed every time the rights managing unit 33 receives the right-of-use information from a remote server or a medium such as a CD-ROM, after the information processing device is activated. When the right-of-use information is deleted or updated, the device driver identification information in the deleted or updated right-of-use information is transferred from the rights managing unit 33 to the access determining unit 31 via the control information converting unit 32. The access determining unit 31 then deletes or updates the control information corresponding to the received device driver identification information.

Referring now to FIG. 3, the operation to be performed when the application 1 accesses the device 4 is described.

Where the application 1 is to control the device 4, it is necessary for the application 1 to access the device driver 22. To access the device driver 22, the application 1 issues a control instruction to the device driver 22 via the system call unit 21. Here, the application 1 also issues the device driver identifier for identifying the device driver 22 to the system call unit 21.

After receiving the control instruction and the device driver identifier (step B1), the system call unit 21 requests the access determining unit 31 to determine whether access to the device driver 22 is allowed, so as to confirm whether access to the device driver 22 is allowed. Here, the system call unit 21 transfers the received device driver identifier to the access determining unit 31.

Based on the device driver identifier received from the system call unit 21, the access determining unit 31 searches for the control information that contains the device driver identification information for identifying the device driver 22 to be controlled. If the control information is found as a result of the search, the access determining unit 31 determines whether the right of use has been given (step B2). If the right of use has been given (“YES” in step B2), the access determining unit 31 allows the system call unit 21 to access the device driver 22, and notifies the system call unit 21 of the allowance (step B3). After the system call unit 21 is notified that access to the device driver 22 is allowed, the system call unit 21 notifies the device driver 22 of the control instruction as to the device 4 (step B3). The device driver 22 received the control instruction of the device 4 begins to control the device 4 (step B4).

On the other hand, if the access determining unit 31 determines that the control information corresponding to the device driver identifier is not stored in the access determining unit 31 as a result of the search for the control information, or that the right of use has not been given (“NO” in step B2), the access determining unit 31 notifies the system call unit 21 of an error (step B5).

When determining whether access to the device driver 22 is allowed, the access determining unit 31 obtains detailed information that can be extracted based on the device driver identifier, such as the associations with the version of the device 4, the special file name, and the driver name, from the system call unit 21 or the like. The access determining unit 31 then compares the information with the device driver identification information, so as to determine whether access to the device driver 22 is allowed.

The control of the device 4 by the device driver 22 is initiated by startup access (a control instruction) from the application 1, and is ended by closing access (a control instruction) from the application 1. The access to the device driver 22 from the application 1 during this period is all carried out through the procedures shown in FIG. 3. Accordingly, the use of right may be lost during the time between the access start and the access termination. More specifically, the control information is deleted or updated in the access determining unit 31 through the procedures of step A1 to step A3 shown in FIG. 2. After that, when the application 1 tries to access the device driver 22, an error is sent from the access determining unit to the system call unit 21.

In accordance with this embodiment, unauthorized use of a device can be prevented by determining whether access to the device driver is allowed. Also, since the control of access to the device driver is performed in the OS, the device can be controlled by determining whether the right of use has been given, instead of modifying an existing code of the device driver controlling the device.

### SECOND EMBODIMENT

Referring now to FIG. 4, an information processing device in accordance with a second embodiment is described.

The information processing device in accordance with the second embodiment differs from the information processing device in accordance with the first embodiment, in that an automatic driver incorporating unit 23 is provided. Therefore, an explanation of the components already described in the first embodiment is omitted.

The automatic driver incorporating unit 23 recognizes the device 4 connected to an interface such as a USB or PCMCIA, and automatically incorporates the device driver 22 necessary for controlling the device 4 into the OS 2. The operation of incorporating the device driver 22 into the OS 2 is not performed, unless the maintenance of control information as to the device driver 22 is confirmed after the access determining unit 31 confirms the existence of the control information as to the device driver 22. The automatic driver incorporating unit 23 also reads a device identifier from the device 4, and, using the device identifier as the key, detects the device driver identifier of the necessary device driver 22 from a map file that is stored in advance. The map file is a table that shows the associations between device identifiers and device driver identifiers.

Although the system call unit 21 has the function of accessing the access determining unit 31 in the first embodiment, the system call unit 21 does not have the function of accessing the access determining unit 31 in this embodiment.

Referring now to FIGS. 2, 4, 5, and 6, the operation of this embodiment is described in detail.

The operation that is shown in FIG. 2 and is to be performed in the stages before the application 1 accesses the device driver 22 is the same as the operation in the first embodiment, and therefore, repeated explanation is omitted here.

Next, the operation to be performed when the device 4 is connected to an interface such as a USB or PCMCIA is described. When a user connects the device 4 to an interface such as a USB or PCMCIA (step C1), the automatic driver incorporating unit 23 reads the device identifier of the device 4, and, using the device identifier as the key, searches a map file stored beforehand in the automatic driver incorporating unit 23 for the device driver identifier corresponding to the device identifier. After obtaining the device driver identifier corresponding to the device identifier, the automatic driver incorporating unit 23, which is accompanied by the device driver identifier, accesses the access determining unit 31, and the access determining unit 31 determines whether the right of use of the subject device has been given, based on the control information stored in the access determining unit 31 (step C2). This procedure in the access determining unit 31 is the same as the procedure of step B2 of the first embodiment shown in FIG. 3. If the access determining unit 31 determines that the right of use has been given (“YES” in step C2), the automatic driver incorporating unit 23 incorporates the device driver 22 corresponding to the device driver identifier into the OS 2 (step C3). If the access determining unit 31 determines that the right of use has not been given (“NO” in step C2), the automatic driver incorporating unit 23 does not incorporate the device driver 22 into the OS 2, but sends an error notification to the user (step C4).

Next, the operation to be performed to control the device 4 from the application 1, with the device driver 22 being incorporated into the OS 2, is described.

In order to control the device 4, the application 1 issues a control instruction to the device driver 22 (step D1). After the issuance of the control instruction from the application 1, the system call unit 21 accesses the device driver 22 (step D2). The device driver 22 then accesses the device 4, if necessary, and controls the operation of the device 4 (D3).

Lastly, the operation to be performed when the device 4 is cut off from an interface such as a USB or PCMCIA is described. In this case, the automatic driver incorporating unit 23 recognizes the cut-off device 4, and remove the corresponding device driver 22 from the OS 2, thereby terminating this operation.

In accordance with this embodiment, before a device driver 22 is incorporated into the OS 2, the access determining unit 31 determines whether the application 1 is allowed to access the device driver 22. Accordingly, incorporation of an inaccessible device driver 22 into the OS 2 can be prevented. Also, when a device driver 22 is incorporated into the OS 2, a resource such as a memory necessary for maintaining the device driver 22 is used. Therefore, incorporation of an unusable device driver 22 is prevented, so as not to burden the resources such as a memory.

### THIRD EMBODIMENT

Referring back to FIG. 1, an information processing device in accordance with a third embodiment is described.

The structure of the information processing device of this embodiment is the same as the structure of the information processing device of the first embodiment. Accordingly, the operations of the rights managing unit 33 and the access determining unit 31 of this embodiment is described in the following. It should be noted here that the operations of the other components are the same as those of the first embodiment, and therefore, explanation of them is omitted.

The rights managing unit 33 not only manages the existence of the right-of-use information as to each device driver 22, but also manages more detailed use of each device driver 22. More specifically, in addition to the right-of-use information relating to access to the device driver 22, the rights managing unit 33 has the function of providing at least one of the following conditions. The rights managing unit 33 also has the function of determining that the right of use has become invalid because one of the following conditions (a) to (f) is not satisfied any more:

(a) Usable until a certain time comes (for example, usable in ten hours in total);

(b) Usable until a certain date (for example, usable until Dec. 31, 2004);

(c) Usable certain number of times (for example, usable until the number of accesses reaches 100);

(d) Usable only at a certain location (for example, usable only when the information processing device is connected to the internal network of the company);

(e) Usable only on a certain day of the week (for example, usable only on Sundays); and

(f) Usable only during certain hours of the day (for example, usable only from 9:00 to 10:00 everyday).

The access determining unit 31 has the function of notifying the rights managing unit 33 that access to the device driver 22 is started or ended. Every time the access determining unit 31 notifies an access start or end, the rights managing unit 33 updates the right-of-use information and the conditions (a) to (f).

Referring now to FIGS. 2, 3, 7, and 8, the operation of the information processing device in accordance with this embodiment is described.

The operation to be performed in the stages before the device driver 22 is accessed by the application 1 as shown in the flowchart of FIG. 2 is the same as the corresponding operation of the first embodiment, and therefore, explanation of the operation is omitted here. The rights managing unit 33 holds only the device driver identification information and the right-of-use information, and transfers the device driver identification information and the right-of-use information to the control information converting unit 32 in the first embodiment. In this embodiment, on the other hand, the rights managing unit 33 further holds the conditions (a) to (f), and transfers those conditions to the control information converting unit 32.

The operation to be performed when the application 1 accesses the device 4 as shown in the flowchart (step B1 to step B4) of FIG. 3 is also the same as the corresponding operation of the first embodiment. In this embodiment, however, the access determining unit 31 notifies the rights managing unit 33 that access to the device driver 22 from the application 1 is started or terminated. This notification may be sent via the control information converting unit 32, or the access determining unit 31 may send the notification directly to the right managing unit 33.

An operation to be added to the first embodiment is described below.

Referring now to FIG. 7, the operation of deleting or updating the control information stored in the access determining unit 31 when the conditions (a) to (f) held by the rights managing unit 33 are updated is described.

The rights managing unit 33 updates the conditions (a) to (f) for the right-of-use information, whenever necessary. More specifically, based on a notification of a start and end of access to the device driver 22 from the application 1, the rights managing unit updates the conditions (a) to (f) when receiving the notification from the access determining unit 31 or at regular intervals (step E1).

Based on the notification of an access start and end from the access determining unit 31, the rights managing unit 33 updates the conditions (a) to (f) in the following manner:

(a) Reduction of Usage Time

Based on the notification of the start and end of access to the device driver 22 from the application 1, the usage time is calculated, and the usage time is subtracted from the total time during which access is allowed to the device driver 22.

(b) Date Check

Nothing is done here.

(c) Reduction of Access Times

The number of access times is determined based on the notification of the start and end of access to the device driver 22 from the application 1, and the number of access times is subtracted from the total number of times the device driver 22 can be accessed.

(d) Location Check

Nothing is done here.

(e) Day Check

Nothing is done here.

(f) Hour Check

Nothing is done here.

When the right managing unit 33 updates the right-of-use information and the conditions (a) to (f) (step E1), the right-of-use information is determined to be valid if the conditions for access to the device driver 22 from the application 1 are satisfied. More specifically, the following checking is performed with respect to the conditions (a) to (f), and the validity of the right-of-use information as to the corresponding device driver 22 is judged (step E2).

(a) Usage Time Check

The right-of-use information is determined to be valid if there is a remaining usage time.

(b) Date Check

The right-of-use information is determined to be valid if the present date is before the limit date.

(c) Access Times Check

The right-of-use information is determined to be valid if there are a remaining number of access times.

(d) Location Check

The right-of-use information is determined to be valid if the location at which the information processing device is installed or the location at which the information processing device is connected to the network is one of the predetermined locations.

(e) Day Check

The right-of-use information is determined to be valid if the present date is the predetermined day of the week.

(f) Hour Check

The right-of-use information is determined to be valid if the present time is in a certain hour of the day.

If the above conditions are satisfied (“YES” in step E1), the access to the device driver 22 from the application 1 is maintained (step E1). If the above conditions are not satisfied (“NO” in step E2), the right-of-use information is updated, and is transferred together with the device driver identification information to the control information converting unit 32. The control information converting unit 32 converts the received right-of-use information into the control information (step E3), and transfers the control information together with the device driver identification information to the access determining unit 31. The access determining unit 31 deletes the control information containing the device driver identification information identical to the device driver identification information attached to the received control information, and stores the new control information together with the device driver identification information (step E4).

Through the above operation, the control information stored in the access determining unit 31 is updated, and, when a control instruction is issued from the application 1 to the device driver 22, a notification that access to the device driver 22 is not allowed is sent to the user before the device driver 22 is accessed by the application 1.

Next, the operation to be performed by the rights managing unit 33 to update the conditions (a) to (f) upon receipt of a notification of an access start and end from the access determining unit 31 or the control information or right-of-use information from a remote server or a medium, such as a CD-ROM, is described. As shown in FIG. 8, when the rights managing unit 33 receives a notification of an access start and end from the access determining unit 31 or the control information or right-of-use information from a remote server or a medium such as a CD-ROM (step F1), the conditions (a) to (f) are updated in the following manner (step F2).

(a) If there is a remaining period of time during which the device driver 22 can be accessed, the existing remaining period of time is discarded, and is rewritten with a new remaining period of time. Meanwhile, if the usage time is stored as the total access time, a new access time is added to the existing total access time.

(b) As for the limit date, the existing limit date is rewritten with a new limit date. Alternatively, the existing limit date is compared with a new limit date, and is replaced with the new limit date, if the new limit date indicates the later date.

(c) As for the number of access times, the existing number of access times is discarded, and is rewritten with a new number of access times. Alternatively, the number of access times is renewed by adding the new number of access times to the existing number of access times.

(d) As for the location of use, the existing location of use is discarded, and is rewritten with a new location of use. Further, the existing location of use or the new location of use can be the location of use. Alternatively, the wider location of the two is set as the location of use.

(e) As for the day of use, the existing day of the week is discarded, and is written with a new day. Alternatively, the existing day or the new day is set as the day of use.

(f) As for the hour of use, the existing hour of use is discarded, and is rewritten with a new hour of use. Alternatively, the existing hour of use or the new hour of use is set as the hour of use.

When the conditions (a) to (f) are updated through the above procedures (step F2), the control information converting unit 32 converts the right-of-use information into control information (step F3), and transfers the control information to the access determining unit 31, which stores the control information (step F4).

In accordance with this embodiment, access to the device driver 22 can be restricted with higher precision and speed. Please note that the function newly added in this embodiment may also be added to the second embodiment.

### FOURTH EMBODIMENT

The structure of an information processing device in accordance with a fourth embodiment is the same as the structure of the information processing device of the first embodiment shown in FIG. 1. Therefore, the operations of the rights managing unit 33, the control information converting unit 32, the access determining unit 31, the system call unit 21, and the application 1 are described in the following. The operations of the other components are the same as those of the first embodiment, and therefore, explanation of them is omitted.

The rights managing unit 33 manages not only the existence of the rights of use of each device driver 22, but also manages the rights of use in greater detail. The rights managing unit 33 has the function of holding information indicating which application 1 is allowed to use which device driver 22. For example, there are cases where more than one device driver 22 can be accessed by one application 1. Also, there are cases where one device driver 22 can be used by different applications 1. Accordingly, in this embodiment, the rights managing unit 33 holds application identification information for identifying each application 1. As well as the device driver identification information, the application identification information is attached to the right-of-use information. The right-of-use information having the device driver identification information and the application identification information attached thereto is transferred to the control information converting unit 32.

Based on more than one piece of right-of-use information, the control information converting unit 32 associates the application identification information for identifying the applications 1 that can access the device drivers 22, with the device driver identification information for identifying the device drivers 22. The control information converting unit 32 adds the application identification information and the device driver identification information to the control information, and transfers the control information to the access determining unit 31. If the device driver identification information, the application identification information, and the right-of-use information received from the rights managing unit 33 are in a format that can be read by the access determining unit 31, the control information converting unit 32 does not perform the converting operation, and transfers the right-of-use information and the other information to the access determining unit 31.

The access determining unit 31 holds the application identification information for identifying the applications 1 that can access the device drivers 22, the device driver identification information for identifying the device drivers 22, and the control information. The application identification information, the device driver identification information, and the control information are associated with one another. In response to a request from the system call unit 21, the access determining unit 31 determines whether the subject application 1 can access the subject device driver 22, based on the application identification information, the device driver identification information, and the control information. The application identification information held by the access determining unit 31 contains the information for identifying each application 1 based on the application identifier issued from the system call unit 21. Accordingly, the application identification information held by the access determining unit 31 may not be the application identifier issued from the system call unit 21.

Based on the application identifier of the application 1 requesting access to the device driver 22 through the system call unit 21 and the device driver identifier of the device driver 22 to be accessed, the access determining unit 31 searches for the control information containing the corresponding application identification information and the corresponding device identification information. If the control information is found, the access determining unit 31 in return sends a use allowance notification to the system call unit 21. If the control information is not found, the access determining unit 31 in return sends a use prohibition notification to the system call unit 21.

The application 1 sends a control instruction to the system call unit 21. The device driver identifier for identifying the subject device driver 22 is attached to the control instruction. The system call unit 21 determines which application 1 has issued the control instruction, and attaches the obtained information as the application identifier to the control instruction. The control instruction is then transmitted to the access determining unit 31.

In accordance with this embodiment, the applications 1 that can access the device drivers 22 are limited, so that access to the device driver 22 can be more specifically restricted.

Please note that the structure of this embodiment may be applied to the third embodiment.

### FIFTH EMBODIMENT

The structure of an information processing device in accordance with a fifth embodiment is the same as the structure of the information processing device of the second embodiment. Therefore, the operations of the rights managing unit 33, the control information converting unit 32, the access determining unit 31, and the application 1 are described in the following. The operations of the other components are the same as those of the fourth embodiment, and therefore, explanation is omitted.

The rights managing unit 33 manages not only the existence of the rights of use of each device driver 22, but also manages the rights of use in greater detail. The rights managing unit 33 obtains and holds the right-of-use information as to device drivers 22 in an interdependent relationship with each subject device driver 22. This is because there is a possibility that, when a device driver 22 is used, a request for access to the interdependent device driver 22 is issued. Also, there are cases where access to other device drivers 22 is allowed when one device driver 22 is accessed. Every time the rights managing unit 33 obtains and holds the right-of-use information as to a device driver 22, the rights managing unit 33 also obtains and holds the right-of-use information as to each device driver 22 in an interdependent relationship with the subject device driver 22.

The control information converting unit 32 converts the right-of-use information into control information, and associates the control information with the subject device driver identifier. The control information is then transferred to the access determining unit 31.

The access determining unit 31 holds the device driver identifier and the control information associated with each other. In response to a request from the automatic driver incorporating function 23, the access determining unit 31 searches the list, and determines whether access is allowed.

The operation to be performed to store the control information as to each device driver 22 in accordance with this embodiment is substantially the same as in the first embodiment, except for the operation of the control information converting unit 32 (step A2 of FIG. 2). More specifically, more than one device driver identifier is added to the control information, and the control information is then transferred to the access determining unit 31.

The control information to be stored in step A3 of FIG. 2 in the first embodiment needs to indicate the combinations of device drivers 22 that can be used together. Therefore, the control information having device driver identifiers converted or generated in step A2 of FIG. 2 is received from the control information converting unit 32, and the control information is then stored.

The operation of the information processing device in accordance with this embodiment is substantially the same as the operation of the information processing device in accordance with the first embodiment. However, in the information processing device in accordance with this embodiment, when a control instruction is issued from an application 1, the system call unit 21 or the access determining unit 31 checks the interdependent relationship between the device driver 22 to be accessed by the application 1 and another device driver 22. Here, the system call unit 21 or the access determining unit 31 determines whether there is a possibility that a request for access to another device driver 22 is triggered by access to one device driver 22 from the application 1. This interdependent relationship information is obtained by referring to a function table as to each device driver 22 held in the OS 2. As a result of the interdependence checking, the access determining unit 31 obtains the control information as to the device driver to be indirectly accessed by the application 1, and, based on the control information, determines whether access to the device driver 22 is allowed. If the access determining unit 31 determines that access of one device driver 22 is not allowed, the access determining unit 31 sends an error notification to the system call unit 21.

Next, a case where the operation in accordance with this embodiment is applied to the information processing device in accordance with the second embodiment is described. Specifically, the operation to be performed when the device 4 is connected to an interface such as USB or PCMCIA of the information processing device of the second embodiment is described.

When a user connects the device 4 to an interface such as a USB or PCMCIA (step C1), the automatic driver incorporating unit 23 reads out the device identifier of the device 4, and, using the device identifier as the key, searches a map file for the corresponding device driver identifier. The automatic driver incorporating unit 23 then obtains the device driver identifier of the device driver 22 necessary for the device 4. Here, the device 4 may be controlled by more than one device driver 22. In such a case, the automatic driver incorporating unit 23 obtains device driver identifiers from the map file, and transfers the device driver identifiers to the access determining unit 31. The access determining unit 31 determines whether access to each of the corresponding device drivers 22 is allowed. The access determining unit 31 then determines whether all the necessary device drivers 22 can be accessed (step C2).

If the access determining unit 31 determines that all the device drivers 22 can be accessed (“YES” in step C2), the automatic driver incorporating unit 23 incorporates the device drivers 22 corresponding to the device driver identifiers into the OS 2 (step C3). If the access determining unit 31 determines that not all the device drivers 22 can be accessed (“NO” in step C2), the automatic driver incorporating unit 23 sends an error notification to the user (step C4).

In accordance with this embodiment, the applications 1 that can access a device driver 22 are limited, and the allowance of access to device drivers 22 in an interdependent relationship with the device driver 22 is also restricted. In this manner, access to the device driver 22 can be more specifically controlled. Please note that the operation in accordance with this embodiment can also be applied to the information processing devices in accordance with the third and fourth embodiments.

### INDUSTRIAL APPLICABILITY

The present invention can be applied to the use of a sensor temporarily USB-connected to a terminal such as a portable telephone device, or to the use of a rented sensor device. In the case where encrypted content is to be decrypted by a special-purpose device, the present invention can be applied to a service in which only the terminals that have bought the right to see the content are allowed to use the special-purpose device. The present invention can also be applied to a case where a device and a device driver are built in a terminal such as a portable telephone device, and the device can be used after the right of use is purchased.

### BRIEF DESCRIPTION OF THE DRAWINGS

FIG. 1 is a block diagram showing the structure of a first embodiment.

FIG. 2 is a flowchart showing a preprocessing operation of the first embodiment.

FIG. 3 is a flowchart showing an access control operation of the first embodiment.

FIG. 4 is a block diagram showing the structure of a second embodiment.

FIG. 5 is a flowchart showing an access control operation of the second embodiment.

FIG. 6 is a flowchart showing a device access operation of the second embodiment.

FIG. 7 is a flowchart showing a rights information updating operation of a third embodiment.

FIG. 8 is a flowchart showing a right condition updating operation of the third embodiment.

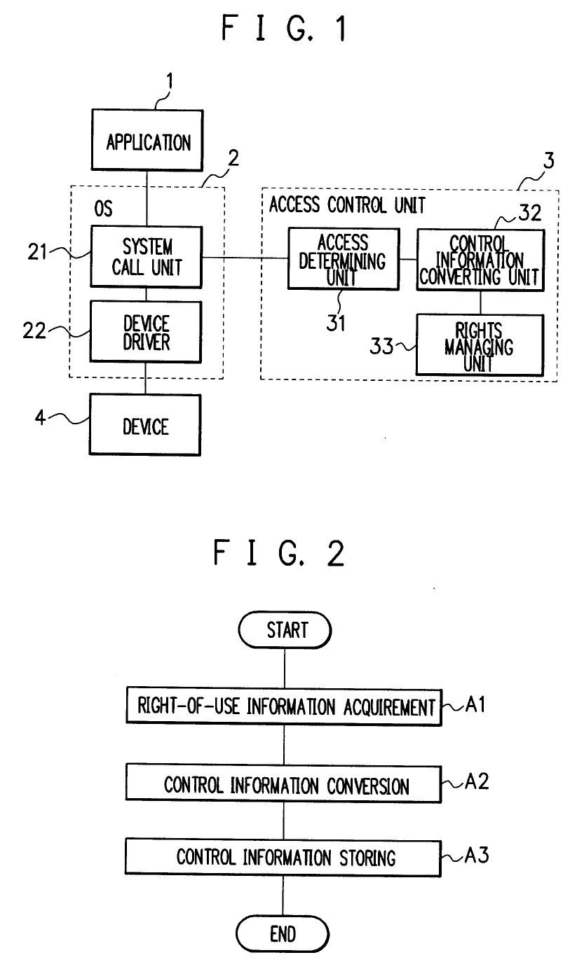

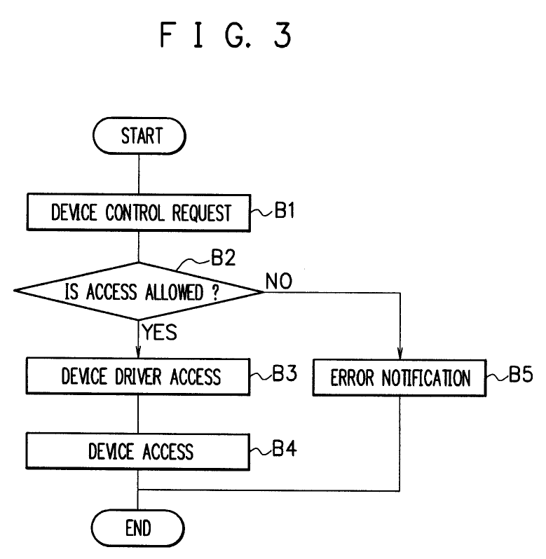

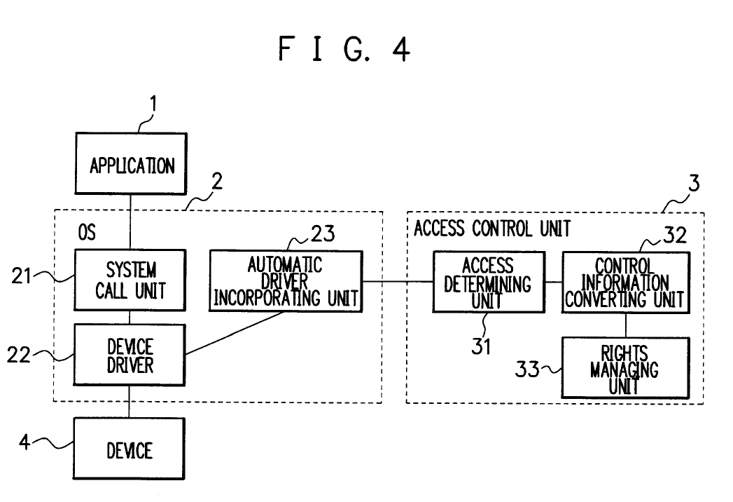

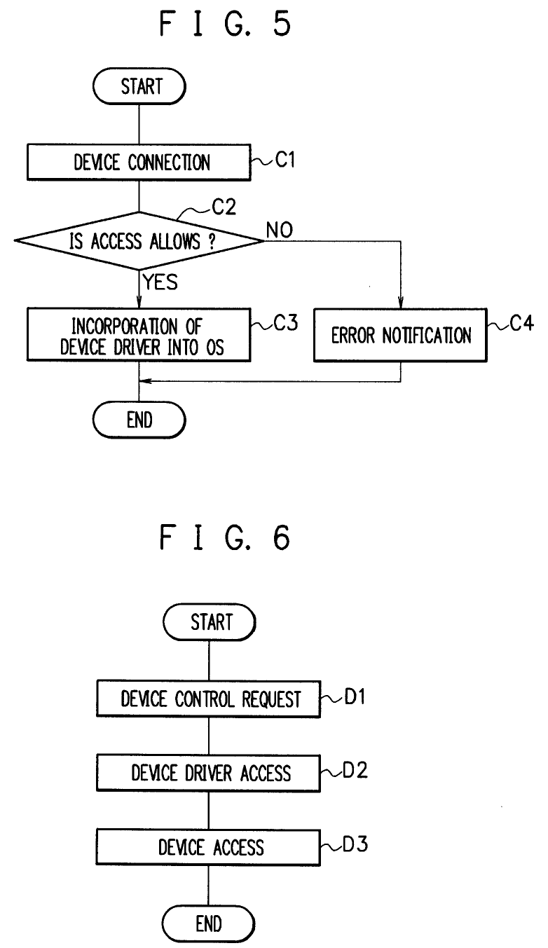

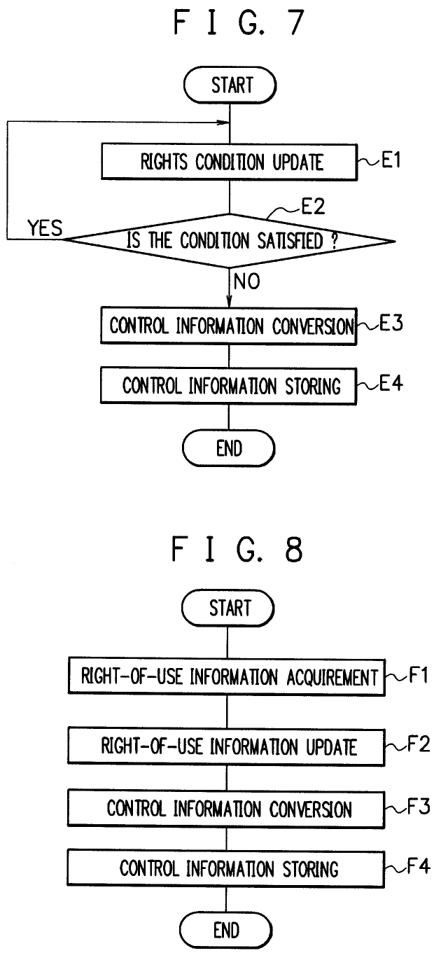

### DESCRIPTION OF THE REFERENCE NUMERAL

1 application
2 OS
3 access control unit
4 device
21 system call unit
22 device driver
23 automatic driver incorporating unit
31 access determining unit
32 control information converting unit
33 rights managing unit

1-79. (canceled)

80. An information processing device that controls a device through a device driver, comprising:
an access determining unit that determines whether access to the device driver is allowed, based on information for identifying an application or the device; and
an operating system that receives, from the application or the device, the information for identifying the application or the device, transfers the information to the access determining unit, and receives, from the access determining unit, a result of the determination as to whether access to the device driver is allowed.

81. An information processing device that controls a device through a device driver, comprising:
an access determining unit that determines whether access to the device driver is allowed, based on information for identifying the device; and
automatic driver incorporating means that: receives, from the device, the information for identifying the device; transfers the information to the access determining unit; receives, from the access determining unit, a result of the determination as to whether access to the device driver is allowed; and incorporates the device driver of the device into an operating system when the result of the determination indicates that access is allowed.

82. The information processing device according claim 80, wherein:
when the device is connected to the information processing device, the access determining unit determines which application is associated with which device, and determines whether control of the device is allowed, based on a control instruction from the application; and
automatic driver incorporating means incorporates the device driver of the device into the operating system, when the access determining unit determines that the application is allowed to control the device.

83. The information processing device according to claim 81, wherein:
when the device is connected to the information processing device, the access determining unit determines which application is associated with which device, and determines whether control of the device is allowed, based on a control instruction from the application; and
automatic driver incorporating means incorporates the device driver of the device into the operating system, when the access determining unit determines that the application is allowed to control the device.

84. The information processing device according to claim 80, wherein an error notification is sent to the application, when the access determining unit determines not to transfer the control instruction to the device driver.

85. The information processing device according to claim 3, wherein an error notification is sent to the application, when the access determining unit determines not to transfer the control instruction to the device driver.

86. The information processing device according to claim 80, further comprising notifying means for notifying a user of an error, when the access determining unit determines not to transfer the control instruction to the device driver.

87. The information processing device according to claim 81, further comprising notifying means for notifying a user of an error, when the access determining unit determines not to transfer the control instruction to the device driver.

88. The information processing device according to claim 80, wherein:
when the device is connected to the information processing device, the access determining unit determines which application is associated with which device, and determines whether control of the device is allowed based on a control instruction from the application;
when the access determining unit determines that the application is allowed to control the device, the device driver of the device is incorporated into the operating system; and
when the access determining unit determines not to allow the application to control the device, an error notification is sent to the application or the user.

89. The information processing device according to claim 3, wherein:
when the device is connected to the information processing device, the access determining unit determines which application is associated with which device, and determines whether control of the device is allowed based on a control instruction from the application;
when the access determining unit determines that the application is allowed to control the device, the device driver of the device is incorporated into the operating system; and
when the access determining unit determines not to allow the application to control the device, an error notification is sent to the application or the user.

90. The information processing device according to claim 80, further comprising:
obtaining means for obtaining right-of-use information that indicates whether the use of the device driver is allowed;
holding means for holding the right-of-use information obtained by the obtaining means; and
control information converting means for converting the right-of-use information held by the holding means into control information that can be read by the access determining unit,
wherein the access determining unit determines whether to transfer the control instruction to the device driver, based on the control information converted by the control information converting unit.

91. The information processing device according to claim 81, further comprising:
obtaining means for obtaining right-of-use information that indicates whether the use of the device driver is allowed;
holding means for holding the right-of-use information obtained by the obtaining means; and
control information converting means for converting the right-of-use information held by the holding means into control information that can be read by the access determining unit,
wherein the access determining unit determines whether to transfer the control instruction to the device driver, based on the control information converted by the control information converting unit.

92. The information processing device according to claim 90, wherein:
the right-of-use information includes conditions for using the right-of-use information; and
the holding means determines that the right-of-use information is invalid when the conditions are not satisfied, and the holding means updates or deletes the right-of-use information.

93. The information processing device according to claim 91, wherein:
the right-of-use information includes conditions for using the right-of-use information; and
the holding means determines that the right-of-use information is invalid when the conditions are not satisfied, and the holding means updates or deletes the right-of-use information.

94. The information processing device according to claim 90, wherein, when the right-of-use information is obtained by the obtaining means, the holding means updates the right-of-use information to combined right-of-use information by combining the right-of-use information newly obtained by the obtaining means and the right-of-use information already held by the holding means.

95. The information processing device according to claim 13, wherein, when the right-of-use information is obtained by the obtaining means, the holding means updates the right-of-use information to combined right-of-use information by combining the right-of-use information newly obtained by the obtaining means and the right-of-use information already held by the holding means.

96. The information processing device according to 90, wherein, when the right-of-use information held by the holding means is updated, added, or deleted, the control information corresponding to the right-of-use information is updated, added, or deleted.

97. The information processing device according to claim 91, wherein, when the right-of-use information held by the holding means is updated, added, or deleted, the control information corresponding to the right-of-use information is updated, added, or deleted.

98. The information processing device according to claim 90, wherein the right-of-use information includes at least one of an access period during which the device driver can be accessed from the application, an access limit date, a maximum number of access times, a location of access, an access day of the week, and access hours of the day.

99. The information processing device according to claim 91, wherein the right-of-use information includes at least one of an access period during which the device driver can be accessed from the application, an access limit date, a maximum number of access times, a location of access, an access day of the week, and access hours of the day.

100. The information processing device according to claim 80, wherein:
the control instruction includes a device driver identifier for identifying the device driver;
the control information includes device driver identification information for identifying the device driver; and
the access determining unit searches for the control information, using the device driver identifier as a key,
when the control information including the device driver identification information as to the device driver corresponding to the device driver identifier is not found, the access determining unit determining not to transfer the control instruction to the device driver.

101. The information processing device according to claim 81, wherein:
the control instruction includes a device driver identifier for identifying the device driver;
the control information includes device driver identification information for identifying the device driver; and
the access determining unit searches for the control information, using the device driver identifier as a key,
when the control information including the device driver identification information as to the device driver corresponding to the device driver identifier is not found, the access determining unit determining not to transfer the control instruction to the device driver.

102. The information processing device according to claim 80, wherein:
the control instruction includes a device driver identifier for identifying the device driver;
the control information includes device driver identification information for identifying the device driver and application identification information for identifying the application;
the system call unit adds an application identifier to the control instruction, the application identifier being for identifying the application that issues the control instruction; and
the access determining unit searches for the control information, using the device driver identifier and the application identifier in the control instruction as a key,
the access determining unit determines not to transfer the control instruction to the device driver when the control information including the device driver identification information as to the device driver corresponding to the device driver identifier included in the control instruction and the application identification information as to the application corresponding to the application identifier included in the control instruction is not found.

103. The information processing device according to claim 81, wherein:
the control instruction includes a device driver identifier for identifying the device driver;
the control information includes device driver identification information for identifying the device driver and application identification information for identifying the application;
the system call unit adds an application identifier to the control instruction, the application identifier being for identifying the application that issues the control instruction; and
the access determining unit searches for the control information, using the device driver identifier and the application identifier in the control instruction as a key,
the access determining unit determines not to transfer the control instruction to the device driver when the control information including the device driver identification information as to the device driver corresponding to the device driver identifier included in the control instruction and the application identification information as to the application corresponding to the application identifier included in the control instruction is not found.

104. The information processing device according to claim 80, wherein
the access determining unit searches for control information as to the device driver associated with the device driver, when determining whether to transfer the control instruction to the device driver,
the access determining unit determines to transfer the control instruction to the device driver when the control information as to the device driver associated with the device driver is found.

105. The information processing device according to claim 81, wherein
the access determining unit searches for control information as to the device driver associated with the device driver, when determining whether to transfer the control instruction to the device driver,
the access determining unit determines to transfer the control instruction to the device driver when the control information as to the device driver associated with the device driver is found.

106. A device access control method to be utilized in an information processing device that controls a device through a device driver, comprising the steps of:
determining whether access to the device driver is allowed, based on information for identifying an application or the device, the determining step being carried out by an access determining unit; and
receiving, from the application or the device, the information for identifying the application or the device, transferring the information to the access determining unit, and
receiving, from the access determining unit, a result of the determination as to whether access to the device driver is allowed, the receiving step being carried out by an operating system.

107. A device access control method to be utilized in an information processing device that controls a device through a device driver, comprising the steps of:
determining whether access to the device driver is allowed, based on information for identifying the device, the determining step being carried out by an access determining unit;
receiving, from the device, the information for identifying the device, transferring the information to the access determining unit, and receiving, from the access determining unit, a result of the determination as to whether access to the device driver is allowed, the receiving step; and
automatically incorporating the device driver of the device into an operating system, when the result of the determination indicates that access is allowed.

108. The device access control method according to claim 106, wherein:
automatic driver incorporating means for incorporating the device driver of the device into the operating system is provided; and
the device access control method further comprises the steps of:
determining which application is associated with which device when the device is connected to the information processing device, and determining whether control of the device is allowed, based on a control instruction from the application; and
incorporating the device driver of the device into the operating system, when the access determining unit determines that the application is allowed to control the device, the incorporating step being carried out by the automatic driver incorporating means.

109. The device access control method according to claim 107, wherein:
automatic driver incorporating means for incorporating the device driver of the device into the operating system is provided; and
the device access control method further comprises the steps of:
determining which application is associated with which device when the device is connected to the information processing device, and determining whether control of the device is allowed, based on a control instruction from the application; and
incorporating the device driver of the device into the operating system, when the access determining unit determines that the application is allowed to control the device, the incorporating step being carried out by the automatic driver incorporating means.

110. The device access control method according to claim 106 further comprising the step of notifying the application of an error when the access determining unit determines not to transfer the control instruction to the device driver.

111. The device access control method according to claim 107 further comprising the step of notifying the application of an error when the access determining unit determines not to transfer the control instruction to the device driver.

112. The device access control method according to claim 106, further comprising the step of notifying a user of an error when the access determining unit determines not to transfer the control instruction to the device driver.

113. The device access control method according to claim 107, further comprising the step of notifying a user of an error when the access determining unit determines not to transfer the control instruction to the device driver.

114. The device access control method according to claim 106, wherein:
in the step of determining which application is associated with which device when the device is connected to the information processing device, and determining whether control of the device is allowed based on a control instruction from the application,
when the access determining unit determines that the application is allowed to control the device, the device driver of the device is incorporated into the operating system; and
when the access determining unit determines not to allow the application to control the device, an error notification is sent to the application or the user.

115. The device access control method according to claim 107, wherein:
in the step of determining which application is associated with which device when the device is connected to the information processing device, and determining whether control of the device is allowed based on a control instruction from the application,
when the access determining unit determines that the application is allowed to control the device, the device driver of the device is incorporated into the operating system; and
when the access determining unit determines not to allow the application to control the device, an error notification is sent to the application or the user.

116. The device access control method according to claim 106, further comprising the steps of:
obtaining right-of-use information that indicates whether the use of the device driver is allowed;
holding the right-of-use information obtained in the obtaining step;
converting the right-of-use information into control information that can be read by the access determining unit, when the right-of-use information is held in the holding means; and
determining whether to transfer the control instruction to the device driver, based on the control information converted in the control information converting step, when the system call unit receives the control instruction, the determining step being carried out by the access determining unit.

117. The device access control method according to claim 107, further comprising the steps of:
obtaining right-of-use information that indicates whether the use of the device driver is allowed;
holding the right-of-use information obtained in the obtaining step;
converting the right-of-use information into control information that can be read by the access determining unit, when the right-of-use information is held in the holding means; and
determining whether to transfer the control instruction to the device driver, based on the control information converted in the control information converting step, when the system call unit receives the control instruction, the determining step being carried out by the access determining unit.

118. The device access control method according to claim 116, wherein:
the right-of-use information includes conditions for using the right-of-use information; and
the device access control method further comprises the step of determining that the right-of-use information is invalid when the conditions are not satisfied, and updating or deleting the right-of-use information held in the holding step.

119. The device access control method according to claim 117, wherein:
the right-of-use information includes conditions for using the right-of-use information; and
the device access control method further comprises the step of determining that the right-of-use information is invalid when the conditions are not satisfied, and updating or deleting the right-of-use information held in the holding step.

120. The device access control method according to claim 116, wherein, when the right-of-use information is obtained in the obtaining step, the holding step includes updating the right-of-use information to combined right-of-use information by combining the right-of-use information newly obtained in the obtaining step and the right-of-use information already held in the holding step.

121. The device access control method according to claim 117, wherein, when the right-of-use information is obtained in the obtaining step, the holding step includes updating the right-of-use information to combined right-of-use information by combining the right-of-use information newly obtained in the obtaining step and the right-of-use information already held in the holding step.

122. The device access control method according to 116, further comprising the step of updating, adding, or deleting the control information corresponding to the right-of-use information held in the holding step, when the right-of-use information held in the holding step is updated, added, or deleted.

123. The device access control method according to 117, further comprising the step of updating, adding, or deleting the control information corresponding to the right-of-use information held in the holding step, when the right-of-use information held in the holding step is updated, added, or deleted.

124. The device access control method according to claim 116, wherein the right-of-use information includes at least one of an access period during which the device driver can be accessed from the application, an access limit date, a maximum number of access times, a location of access, an access day of the week, and access hours of the day.

125. The device access control method according to claim 117, wherein the right-of-use information includes at least one of an access period during which the device driver can be accessed from the application, an access limit date, a maximum number of access times, a location of access, an access day of the week, and access hours of the day.

126. The device access control method according to claim 106, wherein:
the control instruction includes a device driver identifier for identifying the device driver;
the control information includes device driver identification information for identifying the device driver; and
the device access control method further comprises the steps of:
searching for the control information, with the use of a key that is the device driver identifier; and
determining not to transfer the control instruction to the device driver, when the control information including the device driver identification information as to the device driver corresponding to the device driver identifier is not found,
the searching step and the determining step being carried out by the access determining unit.

127. The device access control method according to claim 107, wherein:
the control instruction includes a device driver identifier for identifying the device driver;
the control information includes device driver identification information for identifying the device driver; and
the device access control method further comprises the steps of:
searching for the control information, with the use of a key that is the device driver identifier; and
determining not to transfer the control instruction to the device driver, when the control information including the device driver identification information as to the device driver corresponding to the device driver identifier is not found,
the searching step and the determining step being carried out by the access determining unit.

128. The device access control method according to claim 106, wherein:
the control instruction includes a device driver identifier for identifying the device driver;
the control information includes device driver identification information for identifying the device driver and application identification information for identifying the application;
the device access control method further comprises the steps of:
adding an application identifier to the control instruction, the application identifier being for identifying the application that issues the control instruction, the adding step being carried out by the system call unit;
searching for the control information, with the use of a key that is formed with the device driver identifier and the application identifier in the control instruction; and
determining not to transfer the control instruction to the device driver, when the control information including the device driver identification information as to the device driver corresponding to the device driver identifier included in the control instruction and the application identification information as to the application corresponding to the application identifier included in the control instruction is not found,
the searching step and the determining step being carried out by the access determining unit.

129. The device access control method according to claim 107, wherein:
the control instruction includes a device driver identifier for identifying the device driver;
the control information includes device driver identification information for identifying the device driver and application identification information for identifying the application;
the device access control method further comprises the steps of:
adding an application identifier to the control instruction, the application identifier being for identifying the application that issues the control instruction, the adding step being carried out by the system call unit;
searching for the control information, with the use of a key that is formed with the device driver identifier and the application identifier in the control instruction; and
determining not to transfer the control instruction to the device driver, when the control information including the device driver identification information as to the device driver corresponding to the device driver identifier included in the control instruction and the application identification information as to the application corresponding to the application identifier included in the control instruction is not found,
the searching step and the determining step being carried out by the access determining unit.

130. The device access control method according to claim 106, further comprising the steps of:
searching for control information as to a device driver associated with the device driver, when determining whether to transfer the control instruction to the device driver; and
determining to transfer the control instruction to the device driver, when the control information as to the device driver associated with the device driver is found,
the searching step and the determining step being carried out by the access determining unit.

131. The device access control method according to claim 107, further comprising the steps of:
searching for control information as to a device driver associated with the device driver, when determining whether to transfer the control instruction to the device driver; and
determining to transfer the control instruction to the device driver, when the control information as to the device driver associated with the device driver is found,
the searching step and the determining step being carried out by the access determining unit.

132. A device access control program for an information processing device that controls a device through a device driver, the device access control program being executed to carry out the procedures of:
determining whether access to the device driver is allowed, based on information for identifying an application or the device, the determining procedure being carried out by an access determining unit; and
receiving, from the application or the device, the information for identifying the application or the device, transferring the information to the access determining unit, and receiving, from the access determining unit, a result of the determination as to whether access to the device driver is allowed, the receiving procedure being carried out by an operating system.

133. A device access control program to be executed in an information processing device that controls a device through a device driver, the device access control program being executed to carry out the procedures of:
determining whether access to the device driver is allowed, based on information for identifying the device, the determining procedure being carried out by an access determining unit;
receiving, from the device, the information for identifying the device, transferring the information to the access determining unit, and receiving, from the access determining unit, a result of the determination as to whether access to the device driver is allowed, the receiving procedure; and
automatically incorporating the device driver of the device into an operating system, when the result of the determination indicates that access is allowed.

134. The device access control program according to claim 132, wherein:
automatic driver incorporating means for incorporating the device driver of the device into the operating system is provided; and
the device access control program being executed to further carry out the procedures of:
determining which application is associated with which device when the device is connected to the information processing device, and determining whether control of the device is allowed, based on a control instruction from the application; and
incorporating the device driver of the device into the operating system, when the access determining unit determines that the application is allowed to control the device, the incorporating procedure being carried out by the automatic driver incorporating means.

135. The device access control program according to claim 133, wherein:
automatic driver incorporating means for incorporating the device driver of the device into the operating system is provided; and
the device access control program being executed to further carry out the procedures of:
determining which application is associated with which device when the device is connected to the information processing device, and determining whether control of the device is allowed, based on a control instruction from the application; and
incorporating the device driver of the device into the operating system, when the access determining unit determines that the application is allowed to control the device, the incorporating procedure being carried out by the automatic driver incorporating means.

136. The device access control program according to claim 54, which is executed to further carry out the procedure of notifying the application of an error when the access determining unit determines not to transfer the control instruction to the device driver.

137. The device access control program according to claim 133, which is executed to further carry out the procedure of notifying the application of an error when the access determining unit determines not to transfer the control instruction to the device driver.

138. The device access control program according to claim 132, which is executed to further carry out the procedure of notifying a user of an error when the access determining unit determines not to transfer the control instruction to the device driver.

139. The device access control program according to claim 133, which is executed to further carry out the procedure of notifying a user of an error when the access determining unit determines not to transfer the control instruction to the device driver.

140. The device access control program according to claim 132, wherein:
in the procedure of determining which application is associated with which device when the device is connected to the information processing device, and determining whether control of the device is allowed based on a control instruction from the application,
when the access determining unit determines that the application is allowed to control the device, the device driver of the device is incorporated into the operating system; and
when the access determining unit determines not to allow the application to control the device, an error notification is sent to the application or the user.

141. The device access control program according to claim 133, wherein:
in the procedure of determining which application is associated with which device when the device is connected to the information processing device, and determining whether control of the device is allowed based on a control instruction from the application,
when the access determining unit determines that the application is allowed to control the device, the device driver of the device is incorporated into the operating system; and
when the access determining unit determines not to allow the application to control the device, an error notification is sent to the application or the user.

142. The device access control program according to claim 132, which is executed to further carry out the procedures of:
obtaining right-of-use information that indicates whether the use of the device driver is allowed;
holding the right-of-use information obtained in the obtaining procedure;
converting the right-of-use information into control information that can be read by the access determining unit, when the right-of-use information is held in the holding procedure; and
determining whether to transfer the control instruction to the device driver, based on the control information converted in the converting procedure, when the system call unit receives the control instruction, the determining procedure being carried out by the access determining unit.

143. The device access control program according to claim 133, which is executed to further carry out the procedures of:
obtaining right-of-use information that indicates whether the use of the device driver is allowed;
holding the right-of-use information obtained in the obtaining procedure;
converting the right-of-use information into control information that can be read by the access determining unit, when the right-of-use information is held in the holding procedure; and
determining whether to transfer the control instruction to the device driver, based on the control information converted in the converting procedure, when the system call unit receives the control instruction, the determining procedure being carried out by the access determining unit.

144. The device access control program according to claim 142, wherein:
the right-of-use information includes conditions for using the right-of-use information; and
the device access control program is executed to further carry out the procedures of determining that the right-of-use information is invalid when the conditions are not satisfied, and updating or deleting the right-of-use information held in the holding procedure.

145. The device access control program according to claim 143, wherein:
the right-of-use information includes conditions for using the right-of-use information; and
the device access control program is executed to further carry out the procedures of determining that the right-of-use information is invalid when the conditions are not satisfied, and updating or deleting the right-of-use information held in the holding procedure.

146. The device access control program according to claim 142, wherein, when the right-of-use information is obtained in the obtaining procedure, the holding procedure includes updating the right-of-use information to combined right-of-use information by combining the right-of-use information newly obtained in the obtaining procedure and the right-of-use information already held in the holding procedure.

147. The device access control program according to claim 143, wherein, when the right-of-use information is obtained in the obtaining procedure, the holding procedure includes updating the right-of-use information to combined right-of-use information by combining the right-of-use information newly obtained in the obtaining procedure and the right-of-use information already held in the holding procedure.

148. The device access control program according to claim 142, which is executed to further carry out the procedure of updating, adding, or deleting the control information corresponding to the right-of-use information held in the holding procedure, when the right-of-use information held in the holding procedure is updated, added, or deleted.

149. The device access control program according to claim 143, which is executed to further carry out the procedure of updating, adding, or deleting the control information corresponding to the right-of-use information held in the holding procedure, when the right-of-use information held in the holding procedure is updated, added, or deleted.

150. The device access control program according to claim 142, wherein the right-of-use information includes at least one of an access period during which the device driver can be accessed from the application, an access limit date, a maximum number of access times, a location of access, an access day of the week, and access hours of the day.

151. The device access control program according to claim 143, wherein the right-of-use information includes at least one of an access period during which the device driver can be accessed from the application, an access limit date, a maximum number of access times, a location of access, an access day of the week, and access hours of the day.

152. The device access control program according to claim 132, wherein:
the control instruction includes a device driver identifier for identifying the device driver;
the control information includes device driver identification information for identifying the device driver; and
the device access control program being executed to further carry out the procedures of:
searching for the control information, with the use of a key that is the device driver identifier; and
determining not to transfer the control instruction to the device driver, when the control information including the device driver identification information as to the device driver corresponding to the device driver identifier is not found,
the searching procedure and the determining procedure being carried out by the access determining unit.

153. The device access control program according to claim 133, wherein:
the control instruction includes a device driver identifier for identifying the device driver;
the control information includes device driver identification information for identifying the device driver; and
the device access control program being executed to further carry out the procedures of:
searching for the control information, with the use of a key that is the device driver identifier; and
determining not to transfer the control instruction to the device driver, when the control information including the device driver identification information as to the device driver corresponding to the device driver identifier is not found,
the searching procedure and the determining procedure being carried out by the access determining unit.

154. The device access control program according to claim 132, wherein:
the control instruction includes a device driver identifier for identifying the device driver;
the control information includes device driver identification information for identifying the device driver and application identification information for identifying the application;
the device access control program being executed to further carry out the procedures of:
adding an application identifier to the control instruction, the application identifier being for identifying the application that issues the control instruction, the adding procedure being carried out by the system call unit;
searching for the control information, with the use of a key that is formed with the device driver identifier and the application identifier in the control instruction; and
determining not to transfer the control instruction to the device driver, when the control information including the device driver identification information as to the device driver corresponding to the device driver identifier included in the control instruction and the application identification information as to the application corresponding to the application identifier included in the control instruction is not found,
the searching procedure and the determining procedure being carried out by the access determining unit.

155. The device access control program according to claim 133, wherein:
the control instruction includes a device driver identifier for identifying the device driver;
the control information includes device driver identification information for identifying the device driver and application identification information for identifying the application;
the device access control program being executed to further carry out the procedures of:
adding an application identifier to the control instruction, the application identifier being for identifying the application that issues the control instruction, the adding procedure being carried out by the system call unit;
searching for the control information, with the use of a key that is formed with the device driver identifier and the application identifier in the control instruction; and
determining not to transfer the control instruction to the device driver, when the control information including the device driver identification information as to the device driver corresponding to the device driver identifier included in the control instruction and the application identification information as to the application corresponding to the application identifier included in the control instruction is not found,
the searching procedure and the determining procedure being carried out by the access determining unit.

156. The device access control program according to claim 132, which is executed to further carry out the procedures of:
searching for control information as to a device driver associated with the device driver, when determining whether to allow the device driver to control the device; and
determining to transfer the control instruction to the device driver, when the control information as to the device driver associated with the device driver is found,
the searching procedure and the determining procedure being carried out by the access determining unit.

157. The device access control program according to claim 133, which is executed to further carry out the procedures of:
searching for control information as to a device driver associated with the device driver, when determining whether to allow the device driver to control the device; and
determining to transfer the control instruction to the device driver, when the control information as to the device driver associated with the device driver is found,
the searching procedure and the determining procedure being carried out by the access determining unit.
